(19) United States
(12) Patent Application Publication
(10) Pub. No.: US 2003/0182139 A1
(43) Pub. Date: Sep. 25, 2003

(54) Storage, retrieval, and display of contextual art with digital media files

(75) Inventors: Geoffrey H. Harris, Seattle, WA (US); Linda W. Averett, Mercer Island, WA (US); David M. Nadalin, Sammamish, WA (US); Christopher J. Guzak, Kirkland, WA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Microsoft Corporation

(21) Appl. No.: 10/185,491

(22) Filed: Jun. 28, 2002

Related U.S. Application Data
(60) Provisional application No. 60/366,765, filed on Mar. 22, 2002.

(51) Int. Cl. G06F 17/60

(52) U.S. Cl. 705/1

(57) ABSTRACT

Methods and system for processing media content. A client computer stores a media file and sends an identifier of the media file to a server via a data communication network. In response to the identifier, the server retrieves metadata corresponding to the media file from a central database. The client computer executes a media player program adapted to render the media file and display the metadata, which includes an image file related to the content of the media file. The client computer can also display a thumbnail-sized representation of the image file in its shell to graphically represent the directory in which the media file is located.

### TECHNICAL FIELD

The present invention relates to the field of processing digital media content. In particular, this invention relates to storing, retrieving, and displaying contextual art with digital media files to enhance user experience.

### BACKGROUND OF THE INVENTION

Due to recent advances in technology, computer users are now able to enjoy many features that provide an improved user experience, such as playing various media and multimedia content on their personal or laptop computers. For example, most computers today are able to play compact discs (CDs) so users can listen to their favorite musical artists while working on their computers. Additionally, many computers are equipped with digital versatile disc (DVD) drives enabling users to watch movies.

As users become more familiar with advanced features on their computers, such as those mentioned above, their expectations of the various additional innovative features will undoubtedly continue to grow. For example, consider a media player software application that enables a user to play a CD on his or her computer. Typical applications allow the user to display track information associated with the CD by clicking on an appropriate user interface (UI). Such track information usually includes track numbers, song titles, playing times, and the like. Notwithstanding these advances, the user will continue to desire further advancements, creative use of metadata associated with the digital media, to improve the experience.

Accordingly, this invention arose out of concerns for providing improved systems and methods for processing media content that provide an improved, rich, and robust user experience.

### SUMMARY OF THE INVENTION

The invention meets the above needs and overcomes one or more deficiencies in the prior art by providing improved user experience when playing various media, including CDs and DVDs. The invention electronically acquires and stores content-related images (e.g., album cover art) for digital media. In particular, a computer operating in accordance with the invention executes software routines to retrieve, store, and display these contextual images in conjunction with rendering the digital media files themselves to the user. The invention enhances user experience for digital media by displaying metadata associated with the media, including the contextual art files. The invention also shows the retrieved and stored album art, for example, to the user in a contextual manner when browsing in a shell or playing the content in a media player application program. The software routines of the invention increase the attractiveness of the media player program and operating system to digital media enthusiasts. The invention also presents the user with contextual purchase opportunities and permits the user to select custom art for use instead of the retrieved images. Moreover, the features of the present invention described herein are less laborious and easier to implement than currently available techniques as well as being economically feasible and commercially practical.

Briefly described, a method of processing media content embodying aspects of the invention includes storing at least one media file in the memory of a client computer. The media file is adapted for rendering by a media player program executed by the client computer. The method also includes sending an identifier of the media file from the client computer to a server associated with a central database, which stores metadata for media files. The method proceeds by retrieving metadata, including a content-related image file corresponding to the stored media file, from the central database in response to the identifier sent from the client computer to the server. The method further includes displaying the image file by the client computer when the media player program renders the stored media file.

In another embodiment, a method of processing media content includes determining whether a user-selected image file directly corresponds to a media file to be rendered with a media player program and, if so, displaying the user-selected image file when the media player program renders the media file corresponding thereto.

Yet another embodiment of the invention is directed to a method of processing media content by a client computer. An operating system installed on the client computer has a shell that provides an interface between the operating system and a user of the client computer. In this embodiment, the method includes storing at least one media file in a memory associated with a client computer and defining a directory in which the stored media file is located. The method also includes storing at least one image file corresponding to the stored media file in the memory of the client computer. The method proceeds by graphically representing the directory in which the stored media file is located by displaying a thumbnail-sized representation of the image file in the shell.

Another method of processing media content embodying aspects of the invention includes storing, in a central database, metadata corresponding to at least one media file and receiving, by a server associated with the central database, an identifier of the media file. The method further includes retrieving metadata corresponding to the media file from the central database in response to the received identifier. In this embodiment, the retrieved metadata includes at least one image file corresponding to the media file. According to the invention, the method sends the retrieved metadata to a client computer for displaying the image file when a media player program renders the media file.

Computer-readable media having computer-executable instructions for performing methods of processing media content embody further aspects of the invention.

Yet another embodiment of the invention is directed to a system for processing media content. The system includes a central database, a server associated with the central database, and a client computer. The client computer has a memory storing at least one media file. The server receives an identifier of the stored media file sent by the client computer via a data communication network and, in response to the identifier, retrieves metadata corresponding to the stored media file from the central database. The metadata includes at least one image file corresponding to the stored media file. The client computer then displays the image file when the media player program renders the stored media file.

Alternatively, the invention may comprise various other methods and apparatuses.

Other features will be in part apparent and in part pointed out hereinafter.

### BRIEF DESCRIPTION OF THE DRAWINGS

FIG. 1 is a block diagram of a computer system embodying aspects of one embodiment of the present invention.

FIG. 2 is an exemplary flow diagram illustrating aspects of the operation of the system of FIG. 1.

FIG. 3 is an exemplary flow diagram illustrating further aspects of the operation of the system of FIG. 1.

FIG. 4 is an exemplary embodiment of a small album art image file displayed in a media player application program.

FIG. 5 is an exemplary embodiment of a large album art image file displayed in a media player application program.

FIG. 6 is an exemplary embodiment of a placeholder image file.

FIG. 7 is an exemplary embodiment of a folder view of album art.

FIG. 8 is an exemplary flow diagram illustrating yet further aspects of the operation of the system of FIG. 1.

FIG. 9A and FIG. 9B are exemplary embodiments of a purchase opportunity displayed in a media player application program.

FIG. 10 is a block diagram illustrating one example of a suitable computing system environment on which the invention may be implemented.

Corresponding reference characters indicate corresponding parts throughout the drawings.

### DETAILED DESCRIPTION OF THE INVENTION

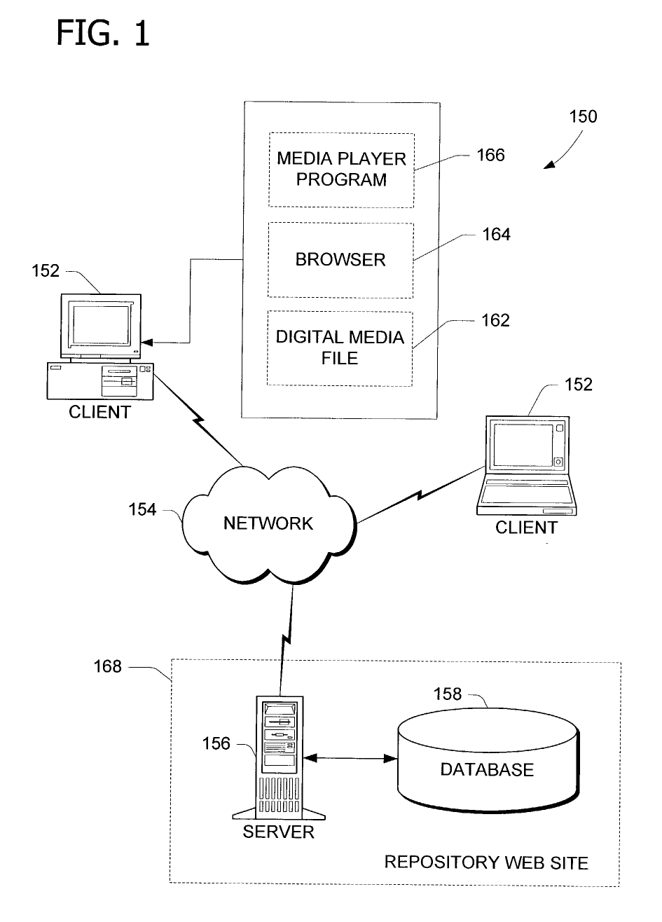

Referring now to the drawings, FIG. 1 illustrates an exemplary network environment in which the present invention can be implemented. A system 150 has one or more client computers 152 coupled to a data communication network 154. One or more server computers 156, sometimes referred to as “web servers” or “network servers,” are also coupled to the network 154. In turn, the client computer 152 can access the server 156 via network 154. As shown in FIG. 1, the system 150 also includes one or more databases 158 associated with server 156.

In this example, network 154 is the Internet (or the World Wide Web). However, the teachings of the present invention can be applied to any data communication network. Server 156 and client computer 152 communicate in the illustrated embodiment using the hypertext transfer protocol (HTTP), a protocol commonly used on the Internet to exchange information.

The invention provides software routines that, when executed by a computer, retrieve, store, and display contextual image files. Referring further to FIG. 1, the user's computer 152 accesses a digital media file 162, such as one residing on a compact disc (CD) or other suitable computer storage media. Client computer 152 also executes a web browser 164 and a media player application program 166. In this embodiment, server 156 and its associated database 158 form a repository web site 168 with which computer 152 communicates via network 154 to access data stored in database 158. The media player program 166 can be any suitable media player that is configured to play digital media so that a user can experience the content that is embodied on the media. For example, suitable media player applications include a CD media player application and a DVD media player application.

One aspect of the present invention enables the user or, particularly, enables media player program 166 executed on a computing device or client, to access, retrieve, and display for the user, so-called metadata. Those skilled in the art are familiar with metadata, which is simply information about data. In the context of the present invention, metadata includes information related to specific content of digital media file 162 being played on the media player 166. Basic metadata includes title, composer, performer, genre, description of content, and the like. Extended metadata includes cover art, performer biographies, reviews, related performers, where to buy similar items, upcoming concerts, ticket sales, URLs to other related experiences including purchase opportunities, and the like.

In the embodiment of FIG. 1, server 156 matches the metadata stored in database 158 to the specific media content that is being experienced by the user. Server 156 then returns the metadata to the user's computer 152. In the examples herein, the media content of digital media file 162 is described in the context of content embodied on a CD or a DVD. It is to be appreciated and understood that the media content can be embodied on any suitable media, including digital files downloaded to the client computer's memory, and that the specific examples described herein are given to further understanding of the inventive principles. For convenience, digital media file 162 refers to one or more files representing, for example, a single song track or a collection of tracks such as would be found on an audio CD. The media content can include, without limitation, specially encoded media content in the form of, for example, an encoded media file such as media content encoded in Microsoft® Windows Media TM format using the Microsoft® Windows Media™ Player program.

Various features of the described systems and methods include a set of databases, client side executable code, and a series of server side processes that provide for querying and maintaining the databases. One logical organization of exemplary system 150 includes a process to map a piece of physical media (embodied by digital media file 162) to a unique database key or, as referred to herein, a “logical ID.” This organization also includes a query process to retrieve information from database 158 based on the unique database key or logical ID. A data return mechanism and schema set returns data and a user feedback system allows users to contribute to the set of understood keys or logical IDs. The logical organization of system 150 also includes a set of management processes that handle user contributions.

The resultant system 150 permits the user to play media file 162 on an enabled media playing device (e.g., computer 152 running Microsoft® Windows® operating system and Windows Media™ Player) and expect not only to experience the media content but also have access to all manner of related metadata. In addition, the user community has the ability to contribute key information to the process to improve the experience for other users.

In system 150, the user-on the client side inserts the media into computer 152, or otherwise causes the content of media file 162 to be experienced. Computer 152 uses a physical ID identifying media file 162 to access the logical ID that uniquely identifies the media. Server 156 then uses the logical ID as the basis for metadata queries of database 158. These queries are designed to retrieve a rich set of related metadata for the user. Server 156 then returns the metadata to client computer 152 via network 154 for display to the user.

The description below will provide detailed aspects of the above systems and various methods that all contribute to a much richer user experience.

In one described embodiment, each media file 162 in which the content that is to be experienced by the user resides has a physical ID associated therewith. The physical ID is assigned or otherwise associated with a logical ID, which is then used as the basis for any database queries. With respect to the physical IDs that are associated with the media, any suitable method or technique of generating a physical ID can be used. For example, when a user inserts a piece of media into a properly configured and enabled device, software code can execute and read data from the physical media. The software code can then compose a unique or nearly unique physical ID from that data.

In the case where the media comprises a CD, the software code can read the offsets (in frames, which have a resolution of 1/72^{nd} of a second) of each track on the disc. A composite key or physical ID is then built from a string of the hex values of these offsets, prefaced by a number of tracks on the disc and finished with a representation of the total length of the disc.

In the case where the media comprises a DVD, the software code can read the first 64 kilobytes of two files that are guaranteed to be on every DVD. These files are VIDEO_TS.IFO and VTS_{—}01_{—}0.IFO. The former contains main-menu information (VMGI), and the latter contains title set information (VTSI) for the first title on the DVD. After the appropriate data blocks are read, the code generates a 64-bit CRC (cyclic redundancy code) checksum of the data, resulting in an appropriately unique key or physical ID. Of course, it is to be understood that the above two examples are simply two ways that a physical ID can be generated for two different types of media. Other methods of generating physical IDs, as well as other media types can be employed.

Calculation of the physical IDs takes place, in this example, on the client side by software code that executes on client computer 152. Such code can comprise part of a software-implemented media player (e.g., media player program 166) that is configured to play the media of interest.

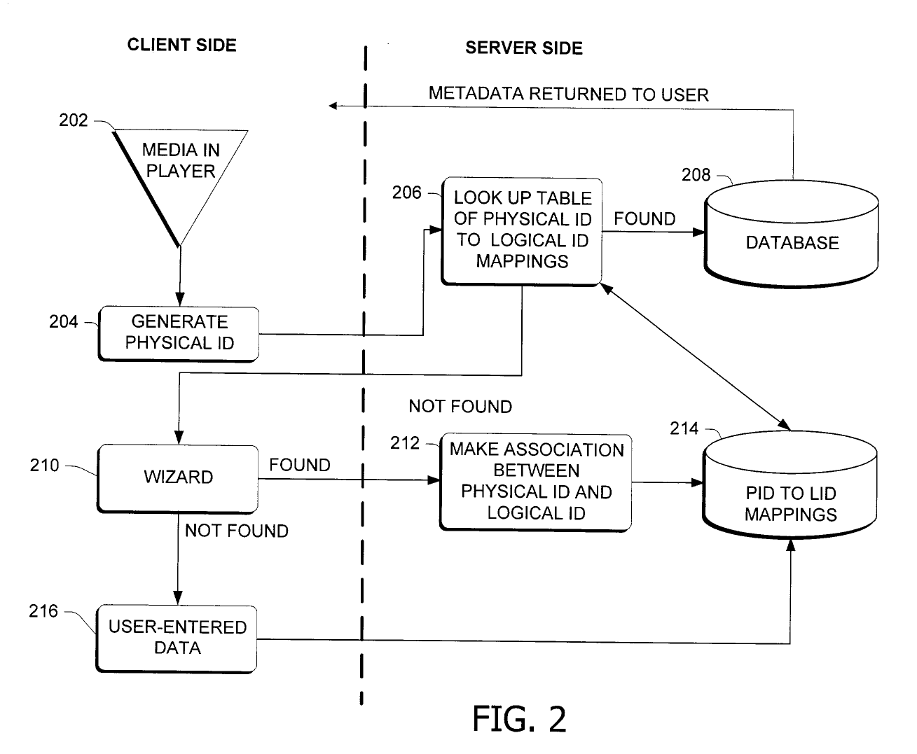

Once the physical IDs are generated, client computer 152 sends the physical IDs to server 156 of the repository web site 168 via network 154 using a suitable protocol. FIG. 2 provides a work flow diagram to assist in understanding the processing that takes place, including generation of the physical IDs. In FIG. 2, the processing takes place on and between the client 152 and the server 156.

At 202, the user accesses a particular piece of digital media using enabled media player program 166, which generates a physical ID for the media at 204. According to one aspect of the invention, accessing the digital media in this manner may include converting the media file to a format compatible with media player program 166 (also referred to as “ripping”). Client computer 152 then bundles up the physical ID and sends it to server 156 for processing. This bundling can be done in any suitable way using any suitable protocols. In one example, the physical ID is passed, through an HTTP URL, to server 156. The server 156 can be configured in any suitable way (e.g., server 156 runs active server pages (ASP) code on the Internet Information Server web services product available from Microsoft Corporation). As will be understood by those skilled in the art, the code can also include a mechanism for converting the ASP request into a query request for a web-enabled database product, which supports for extensible markup language (XML), such as SQL Server also available from Microsoft Corporation.

The server 156 then uses the physical ID to query a lookup table 206 to determine whether there is a proper logical ID associated with it. The logical ID represents the piece of media in a metadata store or database 208 (i.e., database 158). If there is a logical ID associated with the physical ID, then that logical ID serves as a basis for a query of database 208. This query then returns, to the user, metadata associated with the user's media file 162. This metadata comprise a rich collection of data, with non-limiting examples being given above.

If, on the other hand, server 156 does not find a logical ID for the physical ID, then media player program 166 presents a wizard user interface 210 to the user on the client side. The wizard 210 attempts to find or establish the physical ID for the user's media file 162, which, in turn, will be used to establish the logical ID. For example, assume that the user starts playing a CD that has a physical ID that has not yet been processed by system 150. When server 156 attempts to look up a logical ID associated with the media's physical ID, no corresponding logical ID will be found. Accordingly, client computer 152 presents wizard 210 to the user and attempts to identify the user's media file 162. The wizard 210 attempts to identify the user's media because a logical ID that is associated with the media may already exist. For example, the same entitled CD, containing the same songs, can actually have several different physical IDs associated with it, yet there will be only one logical ID to which all of these physical IDs are mapped. If system 150 has not yet processed the physical ID, it will seek to establish an association between that physical ID and the logical ID that already exists in database 208 for that particular CD.

If client computer 152 successfully identifies media file 162 using wizard 210, and a logical ID for the file exists, then server 156 establishes a physical ID to logical ID mapping at 212. In this embodiment, the mapping is for the specific physical ID of the user's media file 162. Server 156 maps the specific physical ID to the logical ID that is associated with the user's media and stores the association in a database 214 (e.g., database 158) that contains physical ID to logical ID mappings.

On the other hand, if wizard 210 is unsuccessful in identifying the particular media file 162, then server 156 accepts data identifying the media entered by the user at 216. In one embodiment, the user-entered data 216 (e.g., title, tracks and artist) establishes a physical ID to logical ID mapping for media file 162, which in turn serves as a logical ID for all subsequent physical IDs associated with the particular media file 162. Consider, for example, a situation in which a particular user is the first system user to play a new CD. In this case, system 150 may not include a logical ID for the new physical media. Accordingly, media player program 166, through wizard 210, prompts the first user to enter any relevant information for the CD (i.e., title, artist, tracks, track titles, and the like), as well as a logical ID for the media so that an association can be established on server 156.

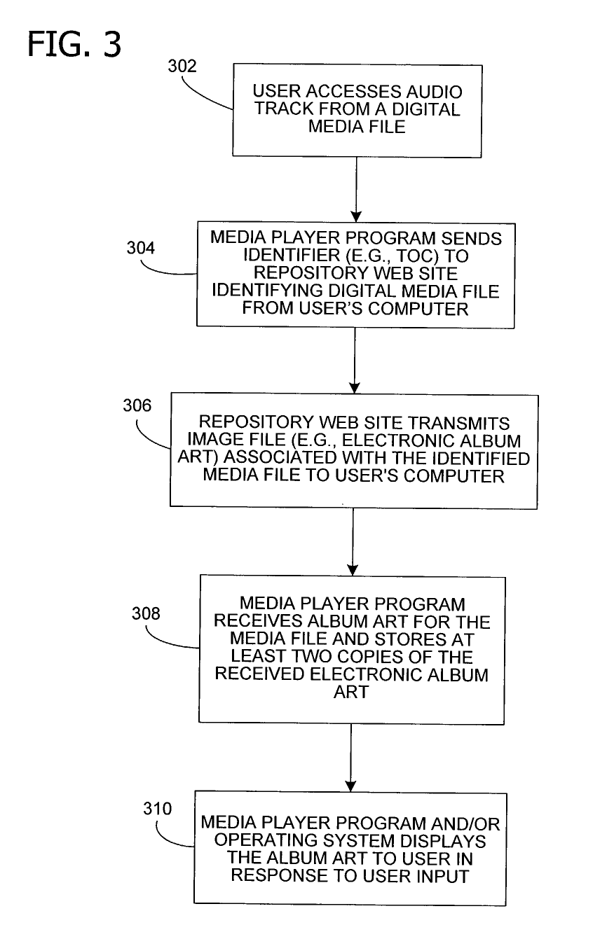

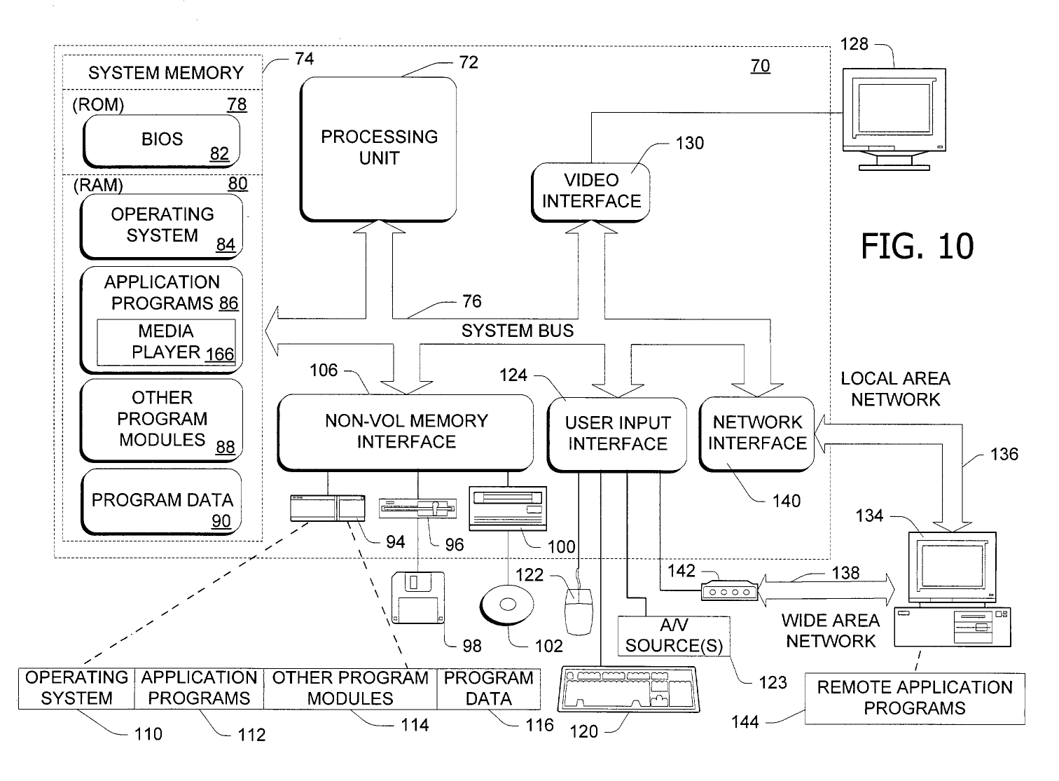

Referring next to FIG. 3, the user accesses (“rips”) at 302 an audio track from a specific digital medium. The ripped track (i.e., digital media file 162) is stored on local storage media associated with the user's computer, such as client computer 152 in FIG. 1 and computer 70 described with reference to FIG. 10. If client computer 152 is connected to network 154, as described with reference to FIG. 1 and FIG. 10, media player program 166 executing on computer 152 sends, at 304, an identifier for digital media file 162 to server 156 of repository web site 168 via network 154. As described above, the identifier may take the form of a physical ID such as a table of contents (TOC) identifying the specific digital media file 162 based on the offsets of each track on the disc. The TOC, defined by a well-known specification referred to as the Red Book, identifies an audio CD based absolute times for the start of each track. The TOC, found in the CD's lead-in area, is expected to be the same for all like-entitled CDs published from the same source.

The repository web site 168 has access to database 158 storing, in addition to other metadata, electronic album cover art associated with the specific digital media file 162. In response to the received TOC (or the mapped logical ID), server 156 transmits at 306 one or more image files associated with the identified media file 162 to the user's computer 152.

The media player program 166 receives at 308 the electronic album art for digital media file 162 and stores a copy in the memory of client computer 152. In one embodiment, repository web site 168 arranges stored image objects in containers, each containing a plurality of thumbnail images and full images and server 156 sends at least two copies of the retrieved electronic album art (one small image file and one larger image file) to computer 152.

According to one embodiment of the invention, the client computer's operating system (see operating system 84 of FIG. 10) as well as its media player program 166 use the electronic album art. At 310, computer 152 displays the received electronic album art in response to user selection. Executing media player program 166, computer 152 displays the electronic album art in two sizes (large or small) in a visualization area of the media player when playing the content of digital media file 162. In addition, computer 152 shows the electronic album art to the user in a contextual manner when browsing in a shell of the operating system to display a graphical folder view of the digital media. Advantageously, client computer 152 need not be online, i.e., connected to repository web site 168 via network 154, to view the image files.

Visualizations enhance user experience by adding a visual component to an audio digital file. In one form, visualizations are COM controls used by media player program 166 to turn audio waveforms into animated graphics. The COM controls are packaged as dynamically linked libraries registered in the operating system registry. When media player program 166 runs, registered custom visualizations are loaded and viewed in accordance with the instructions of the skin being used by the media player.

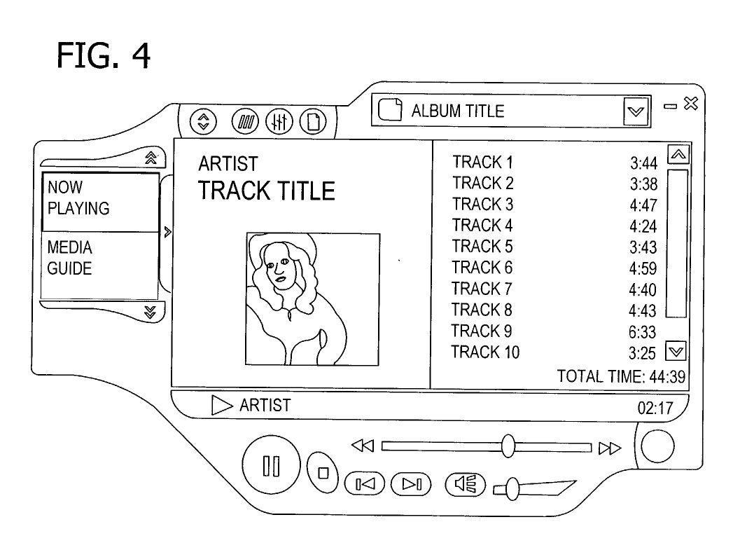

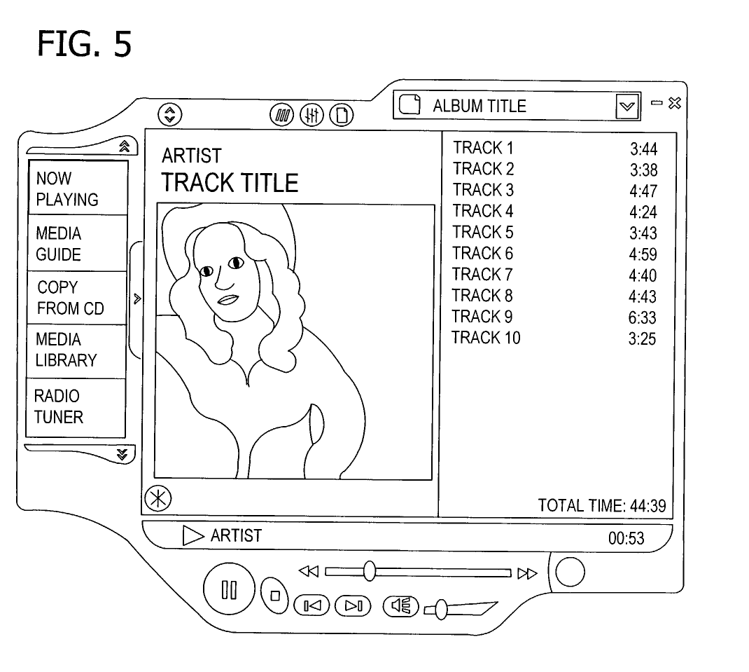

The media player program 166 displays the album art, upon user selection, in different sizes when rendering the content of digital media file 162. In one embodiment, media player program 166 has either large or small “Now Playing” visualization area. These sizes correspond to the album art image file sizes downloaded from repository web site 168 when a track is ripped online. If the user rips the track offline, system 150 does not store the album art until the user subsequently goes online. So until that time, media player program 166 uses a placeholder album art picture. System 150 stores album art files per album with the following naming convention: AlbumArtSmall.jpg (75 pixels×75 pixels) and Folder.jpg (200 pixels×200 pixels). FIG. 4 illustrates an example of album art displayed in the “Now Playing” visualization area using small album art (75 pixels×75 pixels). FIG. 5 illustrates an example of album art displayed in the “Now Playing” visualization area using large album art (200 pixels×200 pixels).

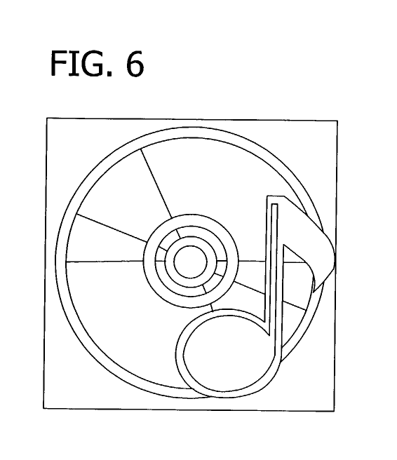

FIG. 6 shows an exemplary image suitable for use as a placeholder image file. It is to be understood that the placeholder image is sized in accordance with the conventions described above.

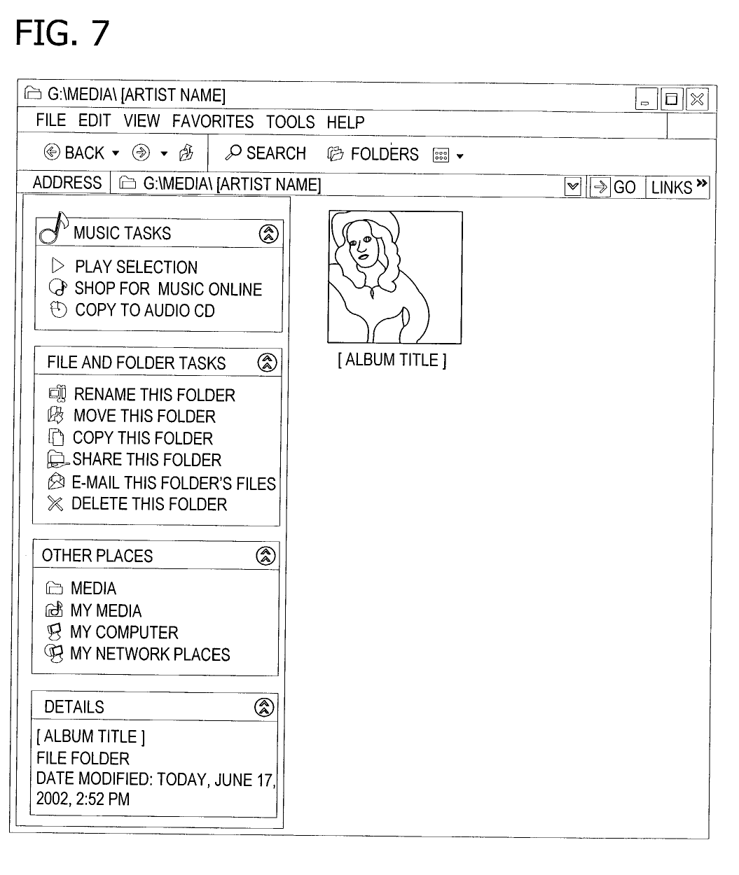

In one embodiment of the present invention, the operating system shell (i.e., the program that provides the operating system's graphical user interface) implements a directory corresponding to the user's digital media files. For example, a “My Music” folder available from the Start menu provides the user with easy access to his or her music files. FIG. 7 illustrates an exemplary embodiment of a folder view of album art along with a side panel Ul for performing various tasks and presenting additional information. This folder permits the user to view thumbnail images of album art, play music, create CDs, search and rearrange music files, and add music to playlists directly from the “My Music” folder. Those skilled in the art recognize that using thumbnail images is more intuitive for a user because the contents or subject of the section can be easily identified as opposed to using a general icon representing the section. Viewing album art in the “My Music” folder makes it easier and more fun for the user to manage his or her music. It is to be understood that similar folders may be used for organizing and managing video and other types of digital media files.

Those skilled in the art will note that operation of software routines of the invention can be implemented in numerous ways all within the scope of the invention. For example, the method illustrated in FIG. 3 may be implemented as a set of application programming interfaces (APIs) available to media player program 166 and to the operating system executing on computer 152. In another embodiment, the software routines described herein may be implemented as an application program executing on computer 152 that interfaces with the operating system and media player program 166 to perform the method illustrated in FIG. 3. In yet another embodiment, the software routines described herein may be implemented as part of the operating system executing on computer 152 with an API available to the media player. Further, as described with reference to FIG. 3, the functionality of the invention may be implemented using commands available in HTTP. In addition, those skilled in the art will note that functionality of the repository web site 168 may be implemented in numerous ways including, but not limited to, an API that interacts with the media player program 166 or operating system of computer 152 to deliver the requested electronic art to computer 152.

The following example illustrates the aspects of the invention described above with reference to FIG. 3. First, when a user rips a track off of a CD while online (i.e., connected to the Internet), media player program 166 sends a TOC to repository web site 168 (e.g., WindowsMedia.com). In turn, repository web site 168 sends one or more selected image files back to client computer 152, which stores them in its memory. According to the example, client computer 152 receives two copies of album cover art (one small image file such as a joint photographic experts group (JPEG) file or .jpg and one larger .jpg) as hidden system files inside a folder corresponding to ripped album. In this regard, the user's digital media files are stored in folders within the “My Music” folder. To view the hidden files, the user selects “Tools”/“Folder Options”/“View” from the “My Music” folder menus. Under the advanced settings, the user selects the “Show hidden files and folders” option and deselects “Hide protected operating system files (Recommended).”

For an even more personal and enhanced user experience, the present invention allows the user to add own custom art to folders. In this example, the user selects the folder to be customized by selecting “View”/“Customize this Folder . . . ”/“Folder pictures”/“Choose Pictures” from the “My Music” folder menus. This is particularly advantageous when the user does not like the downloaded album cover art or has a folder of downloaded music to which he or she wants to add art. The present invention allows the user to simply select any graphic from the browser 164 operating on computer 152. Saving the custom image file in the corresponding folder as “Folder.jpg” allows media player program 166 to pick it up and display it when it renders the digital media file 162 residing in the folder. When the user does this, a .reg key is set that defines which file should be used for album art, but the .jpg files in the album folder are not overwritten. In any case, media player program 166 looks for the .reg key and uses the custom art defined there. If the .reg key is not set, then, media player program 166 checks for the .jpgs in the album folder.

As mentioned above, one feature of the present invention permits the user to view the downloaded image files in the shell (e.g., in the “My Music” folder) as well as while playing the file using media player program 166. The following example illustrates how the user can view custom artwork in the thumbnail view of the “My Music” folder. First, using an image editor, the user resizes and filters the custom images as needed. In this example, the user saves one 200×200 pixels copy of the image file to the desired “My Documents”\“My Music”\“Artist”\“Album” folder as “Folder.jpg”. After saving the first image, the user saves a 75×75 pixels image in the same folder as “AlbumArtSmall.jpg”. Media player program 166 saves these images as hidden system files. When the users renders the content of media file 162 in the media player, the custom album graphic Folder.jpg is viewable if the visualization window of media player program 166 is sized large. On the other hand, media player program 166 displays AlbumArtSmall.jpg in the small visualization window.

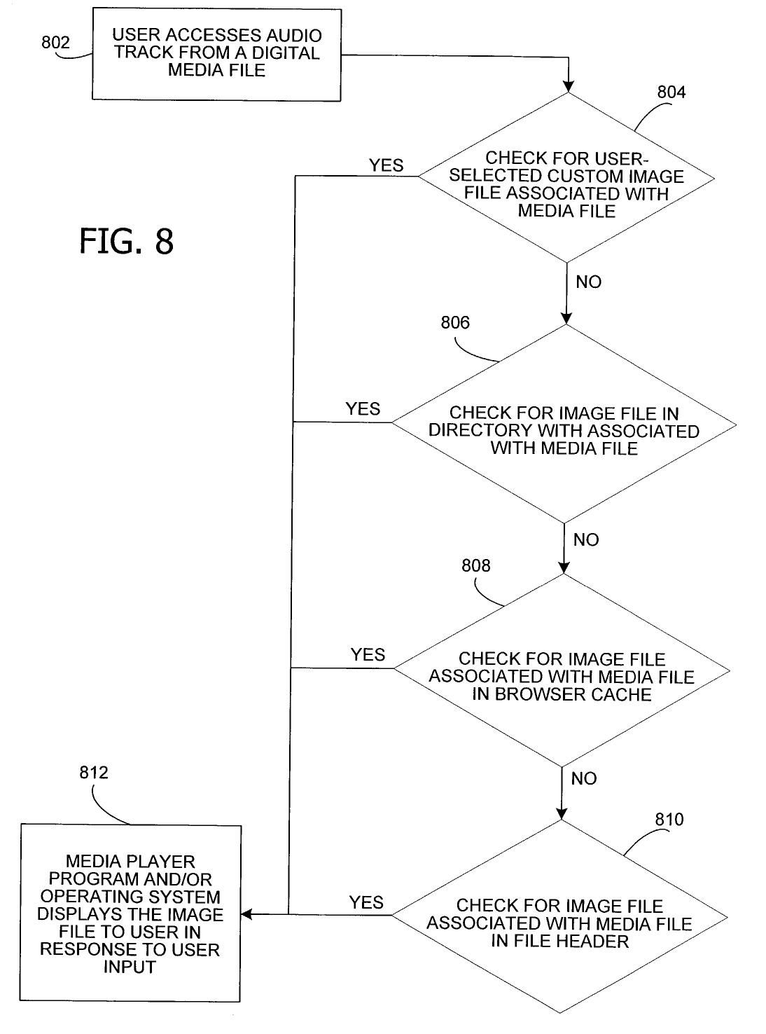

Referring now to FIG. 8 one exemplary embodiment of media player application program 166 looks in four places for album art when the user accesses digital media file 162 at 802. First, the media player checks for customized art at 804. As described above, the user can customize the album art by using the shell's folder options. Second, media player program 166 for the .jpg files in the album folder at 806.

When the album is not ripped and the user is offline, media player program 166 grabs the album art from a cache of browser 164 if available, and shows it in the “Now Playing” visualization window as well as in a media information pane. At 808, the media player program 166 looks for the art third in the cache associated with browser 164 executing on the user's computer 152. Fourth, media player program 166 looks to the digital media file 162 itself. Many media files have headers containing various information about the files. If an image file is unavailable from any of the other sources, the media player program 166 looks in the media file header at 810 for a content-related image file for display when rendering the media file. The album art is then used not only by media player program 166 but also by the operating system shell for a more graphical folder view of an album. At 812, media player program 166 and/or the operating system of computer 152 displays the image file to the user in response to user input.

During playback, media player program 166 will query for and display the album art even if the file is not in the media library. As such, if the user has tracks on a hard drive, for example, that have album art either in the folder or via the customization option, media player program 166 displays the album art to the user in response to a user selection. The media player displays the art even though this file may not be in the library.

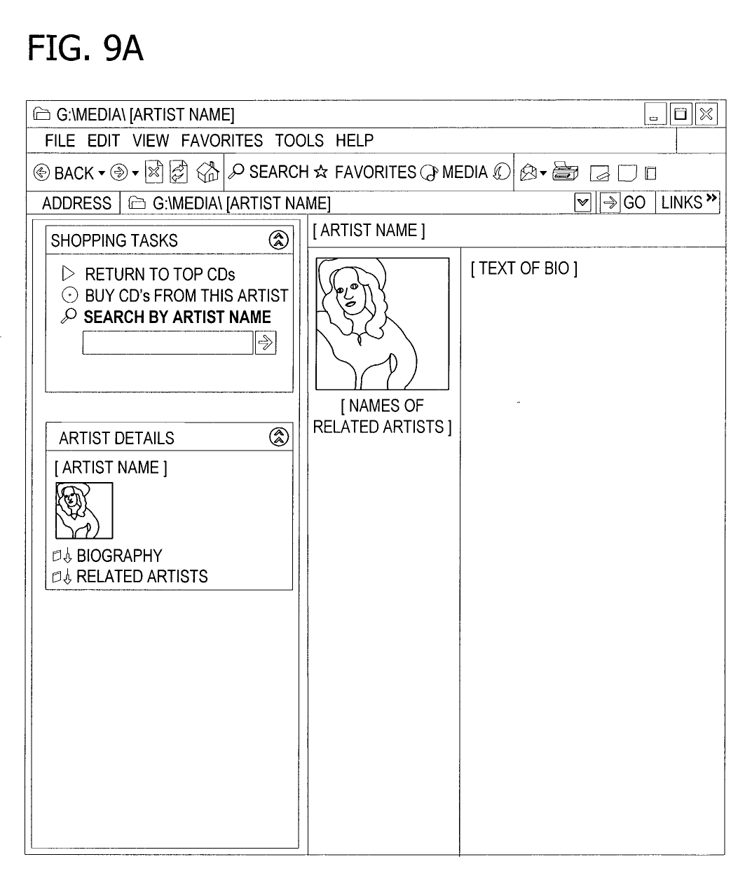

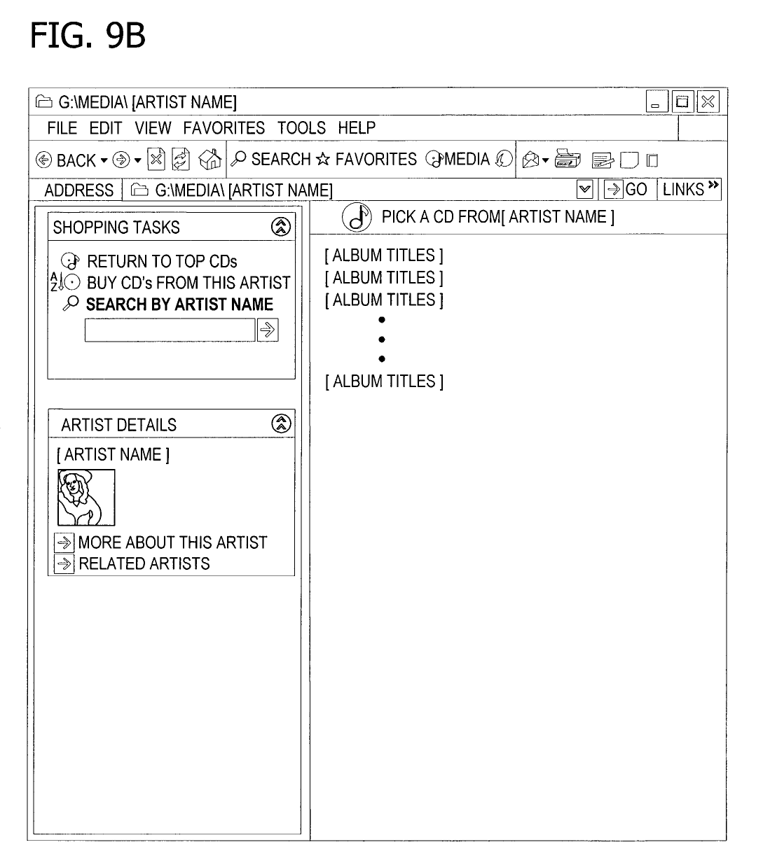

Referring now to FIG. 9A and FIG. 9B, media player program 166 stores the received electronic album art as a hidden system file inside the album folder associated with digital media file 162. System 150 also creates a desktop initialization file inside the ripped album folder. The initialization file (e.g., .ini file) includes a network address of a related purchase opportunity (e.g., MusicBuyURL). In one embodiment, the MusicBuyURL may not be a full network address. Instead, the MusicBuyURL may only include the parameters sent to retrieve the web page.

For example, the full network address for electronic art associated with the Billy Joel album “The Stranger” may be as follows.

http://go.microsoft.com/fwlink/Linkld=493?p_id=P%20%20%20%20%204615&a_id=R%20%20%20%2010432&name=The%20Stranger

However, the MusicBuyURL in the .ini file stores only the subpart of the full network address beginning with “p_id” as follows.

MusicBuyUrl=p_id=P%20%20%20%20%204615&a_id=R%20%20%20%2010432&name=The%20Stranger

These parameters are appended as needed to the appropriate network address to provide the information necessary to complete the network address. An operating system shell has a redirected link that it appends the parameters onto. Media player program 166 has its own link it appends the parameters onto. Using the redirected link allows the network address on the server end to be changed to an appropriate commerce site. This mechanism also prevents someone from simply replacing the network addresses in all the .ini files (such as the desktop.ini files) to point to some other provider. FIGS. 9A and 9B illustrate exemplary screen shots of media player program 166 including a purchase opportunity according to the invention. In FIG. 9A, for example, system 150 presents a first view of a buy opportunity screen in response to the user selecting “Shop for Music Online” from the folder view of FIG. 7. By selecting “Related Artists,” the user proceeds to a second view of the buy opportunity screen, as shown in FIG. 9B.

FIG. 10 shows one example of a general purpose computing device in the form of a computer 70. In one embodiment of the invention, a computer such as the computer 70 is suitable for use in executing media player program 166.

In the illustrated embodiment, computer 70 has one or more processors or processing units 72 and a system memory 74. A system bus 76 couples various system components including the system memory 74 to the processors 72. The bus 76 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 70 has at least some form of computer readable media in FIG. 10. Computer readable media may be any available medium that can be accessed locally or remotely by computer 70. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can accessed by computer 70. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 74 includes computer storage media in the form of removable and/or non-removable, volatile and/or nonvolatile memory. In the illustrated embodiment, system memory 74 includes read only memory (ROM) 78 and random access memory (RAM) 80. A basic input/output system 82 (BIOS), containing the basic routines that help to transfer information between elements within computer 70, such as during startup, is typically stored in ROM 78. The RAM 80 typically contains data and/or program modules that are immediately accessible to and/or presently being operated on by processing unit 72. By way of example, and not limitation, FIG. 10 illustrates operating system 84, application programs 86 (e.g., media player 166), other program modules 88, and program data 90.

The computer 70 may also include other removable/non-removable, volatile/nonvolatile computer storage media. For example, FIG. 10 illustrates a hard disk drive 94 that reads from or writes to non-removable, nonvolatile magnetic media. FIG. 10 also shows a magnetic disk drive 96 that reads from or writes to a removable, nonvolatile magnetic disk 98, and an optical disk drive 100 that reads from or writes to a removable, nonvolatile optical disk 102 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 84, and magnetic disk drive 96 and optical disk drive 100 are typically connected to the system bus 76 by a non-volatile memory interface, such as interface 106. In the present invention, interface 106 is suitable for access to computer-readable medium 802.

The drives or other mass storage devices and their associated computer storage media discussed above and illustrated in FIG. 10, provide storage of computer readable instructions, data structures, program modules and other data for the computer 70. In FIG. 10, for example, hard disk drive 94 stores operating system 110, application programs 112, other program modules 114, and program data 116. Note that these components can either be the same as or different from operating system 84, application programs 86, other program modules 88, and program data 90. Operating system 110, application programs 112, other program modules 114, and program data 116 are given different numbers here to illustrate that, at a minimum, they are different copies.

For purposes of illustration, programs and other executable program components, such as the operating system 84, 110, are illustrated herein as discrete blocks. It is recognized, however, that such programs and components reside at various times in different storage components of the computer, and are executed by the data processor(s) of the computer. For example, FIG. 10 shows media player 166 stored in system memory 74. Those skilled in the art understand that components of media player 166 may reside in system memory 74, hard disk drive 94, or both.

Referring further to FIG. 10, a user may enter commands and information into computer 70 through input devices such as a keyboard 120 and a pointing device 122 (e.g., a mouse, trackball, pen, or touch pad). Other input devices known in the art include an audio/video input device(s) 123 as well as a microphone, joystick, game pad, satellite dish, scanner, or the like (not shown). These and other input devices are connected to processing unit 72 through a user input interface 124 that is coupled to system bus 76, but may be connected by other interface and bus structures, such as a parallel port, game port, or a universal serial bus (USB). As is well known in the art, application programs 86, 112 are often configured to present a user interface (UI). The UI allows a user to interact with the application program in some manner using some type of input device (e.g., keyboard 120 or pointing device 122). This UI is typically a visual display that is capable of receiving user input and processing that user input in some way. By way of example, the UI presents one or more buttons or controls that can be clicked on by a user.

A monitor 128 or other type of display device is also connected to system bus 76 via an interface, such as a video interface 130. In addition to the monitor 128, computers often include other peripheral output devices (not shown) such as a printer and speakers, which may be connected through an output peripheral interface (not shown).

The computer 70 may operate in a networked environment using logical connections to one or more remote computers, such as a remote computer 134. The remote computer 134 may be a personal computer, a server, a router, a network PC, a peer device or other common network node, and typically includes many or all of the elements described above relative to computer 70. The logical connections depicted in FIG. 10 include a local area network (LAN) 136 and a wide area network (WAN) 138, but may also include other networks. Such networking environments are commonplace in offices, enterprise-wide computer networks, intranets, and global computer networks (e.g., the Internet).

When used in a local area networking environment, computer 70 is connected to the LAN 136 through a network interface or adapter 140. When used in a wide area networking environment, such as the Internet, computer 70 typically includes a modem 142 or other means for establishing communications over the WAN 138. The modem 142, which may be internal or external, is connected to system bus 76 via the user input interface 134, or other appropriate mechanism. In a networked environment, program modules depicted relative to computer 70, or portions thereof, may be stored in a remote memory storage device (not shown). By way of example, and not limitation, FIG. 10 illustrates remote application programs 144 as residing on the memory device. It will be appreciated that the network connections shown are exemplary and other means of establishing a communications link between the computers may be used.

Generally, the data processors of computer 70 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described below.

Although described in connection with an exemplary computing system environment, including computer 70, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

In operation, computer 70 executes computer-executable instructions such as those illustrated in FIG. 3 to retrieve, store, and display contextual art with digital media files associated with a computer of a user. The computer-executable instructions request electronic art associated with a digital media file from a repository, receive the requested electronic art from the repository, store the received electronic art in one or more media accessible by the computer, and display the stored electronic art to the user in response to user input.

In operation, the client computer of the present invention has a memory storing at least one media file. The server receives an identifier of the stored media file sent by the client computer via a data communication network and, in response to the identifier, retrieves metadata corresponding to the stored media file from the central database. The metadata includes at least one content-related image file corresponding to the stored media file. The client computer then displays the image file when the media player program renders the stored media file. In this embodiment, the memory of the client computer has a directory in which both the stored media file and the image file corresponding thereto are located. As is well known in the art, the client computer's operating system has a shell that provides an interface between the operating system and the user. The shell in this instance graphically represents the directory in which the stored media file is located by displaying a thumbnail-sized representation of the image file.

As described above, the present invention permits the user to customize the display by selecting another image file instead of the image file retrieved from the central database. If the media player program determines that a user-selected image file directly corresponding to the media file is stored in the memory of the client computer, one embodiment of the invention calls for the media player program to display the user-selected image file when rendering the media file.

In the alternative, the media player program displays an image file from the browser cache when either the user-selected image file is unavailable or the image file was not retrieved from the central database. In yet another alternative, it is contemplated that the media file header contains a content-related image file for display when rendering the media file.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A method of processing media content comprising:
storing at least one media file in a memory associated with a client computer, said media file being adapted for rendering by a media player program executed by the client computer;
sending an identifier of the stored media file from the client computer to a server associated with a central database, said central database storing metadata corresponding to media files, said client computer and said server being coupled to a data communication network;
retrieving metadata corresponding to the stored media file from the central database via the data communication network, said metadata being retrieved in response to the identifier sent from the client computer to the server and including at least one image file corresponding to the stored media file, said image file relating to content of the stored media file; and
displaying the image file by the client computer when the media player program renders the stored media file corresponding thereto.

2. The method of claim 1 further comprising defining a directory in which the stored media file is located and storing the image file corresponding to the stored media file in the directory with the stored media file.

3. The method of claim 2 wherein the client computer has an operating system installed thereon, said operating system having a shell providing an interface between the operating system and a user of the client computer, and further comprising graphically representing the directory in which the stored media file is located by displaying a thumbnail-sized representation of the image file in the shell.

4. The method of claim 2 wherein storing the image file comprises storing the image file in the directory with the stored media file as a hidden system file.

5. The method of claim 1 further comprising creating an initialization file for presenting a purchase opportunity to a user of the client computer when the image file corresponding to the stored media file is displayed, said purchase opportunity being related to content of the stored media file.

6. The method of claim 5 further comprising defining a directory in which the stored media file is located and storing the initialization file in the directory with the stored media file.

7. The method of claim 5 wherein the initialization file directs the user to a uniform resource locator for a web service offering the purchase opportunity.

8. The method of claim 1 further comprising converting the media file to a format compatible with the media player program before storing the media file and sending the identifier to the server.

9. The method of claim 1 further comprising displaying a placeholder image file by the client computer when the media player program renders the stored media file if the retrieved metadata does not include the at least one image file corresponding to the stored media file.

10. The method of claim 1 further comprising permitting a user of the client computer to select another image file for display by the client computer instead of the image file of the retrieved metadata when the media player program renders the stored media file.

11. The method of claim 10 further comprising defining a directory in which the stored media file is located and storing the image file of the retrieved metadata in the directory with the stored media file, and wherein the other image file selected by the user for display does not overwrite the image file of the retrieved metadata stored in the directory.

12. The method of claim 1 wherein the retrieved metadata includes content-related data and wherein the content-related data is selected from one or more of the following: title, composer, performer, genre, and description of content of the stored media file.

13. The method of claim 1 wherein the stored media file includes digital content of one or more tracks of a compact disc and wherein the identifier is representative of offset of the tracks on the disc.

14. The method of claim 1 wherein the retrieved metadata includes at least two image files corresponding to the stored media file, said at least two image files being of different sizes when displayed by the client computer.

15. The method of claim 14 further comprising permitting a user of the client computer to select which of the at least two image files corresponding to the stored media file to display when the media player program renders the stored media file corresponding thereto.

16. The method of claim 1 wherein one or more computer-readable media have computer-executable instructions for performing the method of claim 1.

17. A method of processing media content comprising:
determining whether a user-selected image file stored in a memory of a client computer directly corresponds to a media file to be rendered with a media player program executed by the client computer; and
if so, displaying the user-selected image file, by the client computer, when the media player program renders the media file corresponding thereto.

18. The method of claim 17 further comprising:
defining a directory in which the media file is stored in the memory of the client computer;
determining whether a downloaded image file relating to content of the media file is stored in the directory with the media file; and
if so, displaying the downloaded image file, by the client computer, when the media player program renders the media file.

19. The method of claim 18 further comprising:
storing metadata in a central database, said metadata corresponding to media files;
sending an identifier of the media file stored in the directory from the client computer to a server associated with the central database, said client computer and said server being coupled to a data communication network; and
receiving the identifier by the server and retrieving metadata corresponding to the media file stored in the directory from the central database in response to the received identifier, said retrieved metadata including the downloaded image file, said downloaded image file being stored in the directory with the media file.

20. The method of claim 17 wherein the client computer operates a browser configured to permit a user of the client computer to communicate on the data communication network, said browser caching recently accessed files, and further comprising determining whether a cached image file directly corresponds to the media file and, if so, displaying the cached image file, by the client computer, when the media player program renders the media file corresponding thereto.

21. The method of claim 17 wherein the media file has a header containing metadata and further comprising:
determining whether a header image file corresponding to the media file is contained in the header of the media file; and
if so, displaying the header image file, by the client computer, when the media player program renders the media file corresponding thereto.

22. The method of claim 17 wherein one or more computer-readable media have computer-executable instructions for performing the method of claim 17.

23. A method of processing media content comprising:
storing at least one media file in a memory associated with a client computer, said stored media file being adapted for rendering by a media player program executed by the client computer, said client computer having an operating system installed thereon, said operating system having a shell providing an interface between the operating system and a user of the client computer;
defining a directory in which the stored media file is located;
storing at least one image file corresponding to the stored media file in the memory of the client computer; and
graphically representing the directory in which the stored media file is located by displaying a thumbnail-sized representation of the image file in the shell.

24. The method of claim 23 further comprising:
sending an identifier of the stored media file from the client computer to a server associated with a central database, said central database storing metadata corresponding to media files, said client computer and said server being coupled to a data communication network; and
retrieving metadata corresponding to the stored media file from the central database via the data communication network, said metadata being retrieved in response to the identifier sent from the client computer to the server and including the image file corresponding to the media stored in the memory of the client computer, said image file relating to content of the stored media file.

25. The method of claim 24 further comprising converting the media file to a format compatible with the media player program before storing the media file and sending the identifier to the server.

26. The method of claim 24 further comprising displaying a placeholder image file by the client computer when the media player program renders the stored media file corresponding thereto if the retrieved metadata does not include the image file corresponding to the stored media file.

27. The method of claim 24 further comprising permitting a user of the client computer to select another image file for display by the client computer instead of the image file of the retrieved metadata when the media player program renders the stored media file.

28. The method of claim 27 wherein the other image file selected by the user for display does not overwrite the image file of the retrieved metadata.

29. The method of claim 24 wherein the retrieved metadata includes content-related data and wherein the content-related data is selected from one or more of the following: title, composer, performer, genre, and description of content of the stored media file.

30. The method of claim 24 wherein the stored media file includes digital content of one or more tracks of a compact disc and wherein the identifier is representative of offset of the tracks on the disc.

31. The method of claim 24 wherein the retrieved metadata includes at least two image files corresponding to the stored media file, said at least two image files being of different sizes when displayed by the client computer.

32. The method of claim 31 further comprising permitting a user of the client computer to select which of the at least two image files corresponding to the stored media file to display when the media player program renders the stored media file corresponding thereto.

33. The method of claim 23 wherein storing at least one image file comprises storing the image file in the directory with the stored media file.

34. The method of claim 33 wherein storing the image file in the directory with the stored media file comprises storing the image file as a hidden system file.

35. The method of claim 23 further comprising displaying the image file by the client computer when the media player program renders the stored media file corresponding thereto.

36. The method of claim 35 further comprising creating an initialization file for presenting a purchase opportunity to a user of the client computer when the image file corresponding to the stored media file is displayed, said purchase opportunity being related to content of the stored media file.

37. The method of claim 36 further comprising storing the initialization file in the directory with the stored media file.

38. The method of claim 36 wherein the initialization file directs the user to a uniform resource locator for a web service offering the purchase opportunity.

39. The method of claim 23 wherein one or more computer-readable media have computer-executable instructions for performing the method of claim 23.

40. A method of processing media content comprising:
storing metadata in a central database, said metadata corresponding to at least one media file stored in a memory associated with a client computer, said media file being adapted for rendering by a media player program executed by the client computer;
receiving, by a server associated with the central database, an identifier of the stored media file from the client computer, said client computer and said server being coupled to a data communication network;
retrieving metadata corresponding to the stored media file from the central database in response to the received identifier, said retrieved metadata including at least one image file corresponding to the stored media file, said image file relating to content of the stored media file; and
sending the retrieved metadata to the client computer via the data communication network for displaying the image file by the client computer when the media player program renders the stored media file corresponding thereto.

41. The method of claim 40 further comprising creating an initialization file for presenting a purchase opportunity to a user of the client computer when the image file corresponding to the stored media file is displayed, said purchase opportunity being related to content of the stored media file.

42. The method of claim 41 wherein the initialization file directs the user to a uniform resource locator for a web service offering the purchase opportunity.

43. The method of claim 40 wherein the retrieved metadata includes content-related data and wherein the content-related data is selected from one or more of the following: title, composer, performer, genre, and description of content of the stored media file.

44. The method of claim 40 wherein the stored media file includes digital content of one or more tracks of a compact disc and wherein the identifier is representative of offset of the tracks on the disc.

45. The method of claim 40 wherein the retrieved metadata includes at least two image files corresponding to the stored media file, said at least two image files being of different sizes when displayed by the client computer.

46. The method of claim 45 further comprising permitting a user of the client computer to select which of the at least two image files corresponding to the stored media file to display when the media player program renders the stored media file corresponding thereto.

47. The method of claim 40 wherein one or more computer-readable media have computer-executable instructions for performing the method of claim 40.

48. A system for processing media content comprising:
a central database storing metadata corresponding to a plurality of media files;
a client computer coupled to a data communication network, said client computer having a memory storing at least one media file, said stored media file being adapted for rendering by a media player program executed by the client computer; and
a server associated with the central database, said server also being coupled to a data communication network, said server receiving and responsive to an identifier of the stored media file sent by the client computer via the data communication network for retrieving metadata corresponding to the stored media file from the central database, said metadata including at least one image file corresponding to the stored media file, said image file relating to content of the stored media file, said client computer displaying the image file when the media player program renders the stored media file corresponding thereto.

49. The system of claim 48 wherein the memory of the client computer has a directory in which both the stored media file and the image file corresponding thereto are located.

50. The system of claim 49 wherein the client computer has an operating system installed thereon, said operating system having a shell providing an interface between the operating system and a user of the client computer, said shell graphically representing the directory in which the stored media file is located by displaying a thumbnail-sized representation of the image file.

51. The system of claim 49 wherein the image file is stored in the directory with the stored media file as a hidden system file.

52. The system of claim 49 further comprising an initialization file for presenting a purchase opportunity to a user of the client computer when the image file corresponding to the stored media file is displayed, said purchase opportunity being related to content of the stored media file.

53. The system of claim 52 wherein the initialization file is stored in the directory with the stored media file.

54. The system of claim 52 wherein the initialization file directs the user to a uniform resource locator for a web service offering the purchase opportunity.

55. The system of claim 49 further comprising a user-selected image file for display by the client computer instead of the image file of the retrieved metadata corresponding to the stored media file when the media player program renders the stored media file.

56. The system of claim 55 wherein the user-selected image file does not overwrite the image file corresponding to the stored media file stored in the directory with the stored media file.

57. The system of claim 48 further comprising a placeholder image file, said client computer displaying the placeholder image file when the media player program renders the stored media file if the retrieved metadata does not include the at least one image file corresponding to the stored media file.

58. The system of claim 48 wherein the retrieved metadata includes content-related data and wherein the content-related data is selected from one or more of the following: title, composer, performer, genre, and description of content of the stored media file.

59. The system of claim 48 wherein the stored media file includes digital content of one or more tracks of a compact disc and wherein the identifier is representative of offset of the tracks on the disc.

60. The system of claim 48 wherein the retrieved metadata includes at least two image files corresponding to the stored media file, said at least two image files being of different sizes when displayed by the client computer.

61. The system of claim 48 wherein the client computer executing the media player program first determines whether a user-selected image file stored in the memory of the client computer directly corresponds to the stored media file to be rendered with the media player program and, if so, displays the user-selected image file instead of the image file of the retrieved metadata corresponding to the stored media file when the media player program renders the stored media file corresponding thereto.

62. The system of claim 61 wherein the client computer operates a browser configured to permit a user of the client computer to communicate on the data communication network, said browser caching recently accessed files, and wherein the client computer executing the media player program determines whether a cached image file directly corresponds to the stored media file to be rendered by the media player program and, if so, displays the cached image file when the media player program renders the stored media file corresponding thereto and when neither the user-selected image file nor the image file of the retrieved metadata corresponding to the stored media file are available for display.

63. The system of claim 48 wherein the stored media file has a header containing metadata and wherein the client computer executing the media player program determines whether a header image file is contained in the header of the stored media file to be rendered by the media player program and, if so, displays the header image file instead of the image file of the retrieved metadata corresponding to the stored media file when the media player program renders the stored media file.
